(19) United States
(12) Patent Application Publication
(10) Pub. No.: US 2025/0192302 A1
(43) Pub. Date: Jun. 12, 2025

(54) Housing for a Battery System, and Battery System

(71) Applicant: Instagrid GmbH, Ludwigsburg (DE)

(72) Inventors: Sebastian Berning, Stuttgart (DE); Andreas Sedlmayr, Pforzheim (DE)

(21) Appl. No.: 18/856,024

(22) PCT Filed: Mar. 28, 2023
(86) PCT No.: PCT/EP2023/057983

§ 371 Date: Oct. 10, 2024

(30) Foreign Application Priority Data
Apr. 11, 2022 (DE) 10 2022 108 722.0

(51) Int. Cl. H01M 50/24; H01M 50/242; H01M 50/256; H01M 50/264; H01M 50/271; H01M 50/507

(52) U.S. Cl. CPC H01M 50/24; H01M 50/242; H01M 50/256; H01M 50/264; H01M 50/271; H01M 50/507

(57) ABSTRACT

A housing for a battery system having a plurality of battery modules with respectively at least one battery cell, wherein the housing has a first housing half and a second housing half, wherein the first housing half has first guide structures for positive fixing of the battery modules, and wherein the second housing has second guide structures for positive fixing of the battery modules.

Also described is a battery system.

### CROSS-REFERENCE TO RELATED APPLICATIONS

This application is the United States national phase of International Patent Application No. PCT/EP2023/057983 filed Mar. 28, 2023, and claims priority to German Patent Application No. 10 2022 108 722.0 filed Apr. 11, 2022, the disclosures of which are hereby incorporated by reference in their entireties.

### BACKGROUND

### Field

The invention relates to a housing for a battery system as described herein. The invention also relates to a battery system as described herein.

### Description of Related Art

A battery system typically comprises at least one rechargeable battery cell (also referred to as an accumulator) and serves to supply power to electrically powered loads in various application areas without connection to the power grid. Possible application areas for such battery systems are, for example, the construction industry, maintenance and installation services, mobile catering, professional cleaning services, event technology, or film production.

The loads for which such battery systems are used are typically movable units, and it is correspondingly advantageous if the battery system is also movable. Here the battery system should accordingly serve as a mobile provider of mains voltage. Such a battery system must be especially flexible in its use and correspondingly light and robust for mobile use, even under demanding conditions. It should in particular be portable and insensitive to shocks.

Depending on the use case, different configurations of battery systems are conceivable in which individual battery cells are connected with one another in series and/or in parallel in order to achieve the desired output power, the desired capacity, and a desired voltage profile (direct voltage or alternating voltage).

### SUMMARY

The underlying object of the invention is to provide a housing for a battery system, and a battery system, which are especially robust for a mobile usage and in particular satisfy particularly well the mechanical requirements for a mobile, portable, and flexibly usable battery system.

According to the invention, the achievement of the object takes place with the features of the independent claims. Further advantages and practical embodiments are described in conjunction with the dependent claims.

A housing according to the invention serves to accommodate a battery system. Here a battery system should comprise a plurality of individual battery modules which respectively have at least one battery cell and an electronic module. The battery cells are in particular cylindrical lithium ion rechargeables. In particular, six battery cells are respectively assembled into one battery module. The electronic module thereby has in particular a bridge circuit and a control device. The advantage of the assembly of a plurality of individual battery modules into a battery system is that the battery modules are thus present in smaller units and, for example, can be selectively swapped out, in contrast to a single battery block.

The housing has a first housing half and a second housing half that are indirectly or directly connected to one another. “Directly connected with one another” means that the two housing halves are in contact with and touch one another. Given an indirect connection, the contact between the two housing halves is established by at least one third element, for example by the battery modules or end caps, which is explained in more detail in the following. The housing halves thereby respectively have at least one top surface. In particular, the two housing halves can be connected in a connection direction orthogonal to the top surfaces. The housing halves are in particular connected to one another positively or non-positively. The connection can in particular be realized via a screw joint and/or a separate covering. In particular, the longitudinal direction of the battery cells respectively runs from the top surface of the first housing half to the top surface of the second housing half. In particular, the housing has more housing parts in addition to the first housing half and the second housing half.

The first housing half has first guide structures for the positive fixing of the battery modules, and the second housing half has second guide structures for the positive fixing of the battery modules. The battery modules can in particular be entirely positively fixed in the housing via the two housing halves or, if applicable, an additional covering. The battery modules are in particular fixed securely against vibration in all three spatial directions by the top surfaces, the first guide structures, and the second guide structures.

The first guide structures and/or the second guide structures can be designed integrally with the respective housing half. The housing halves are in particular formed from plastic and can be manufactured simply as an injection molded part with the respective guide structures. Alternatively, the guide structures can be designed as an insert which is connected with the respective housing half. The respective housing half can in particular itself have guide structures or means for positioning the insert, in order to realize a definite positioning of the insert in the housing half.

A housing according to the invention can be manufactured especially simply and cost-effectively, and offers a good protection of the battery modules against vibrations and environmental influences.

In particular, the first guide structures are pins that protrude relative to the first housing half, and/or the second guide structures are pins that protrude relative to the second housing half. Here, what are referred to as pins are geometries that stand out relative to the top surface of the respective housing half and whose extent transverse to their extension direction is small in comparison to the dimensions of the housing halves. In the sense of this application, pins can have round and angular geometries. The outer circumference of the pins can have an open geometry. Pins can easily be produced in the injection molding process, for example.

So as to especially save on material, the pins can respectively be used for positive fixing of a plurality of battery modules and/or for positive fixing of a battery module in two directions. In particular, the pins are respectively arranged at a corner of regions provided for battery modules, and preferably at a corner at which a plurality of regions for battery modules adjoin one another. In particular, at least one pin is located at a corner between at least two regions for battery modules. A pin can also serve for positive fixing of up to four battery modules. For this purpose, the pin in particular has an essentially rectangular cross section.

In order to achieve a particularly good fixing of the battery modules, the lateral surfaces of the pins are in particular adapted to the external geometry of the battery modules. The pins preferably have at least one lateral surface that is curved inward. In particular, the pins have four inwardly curved lateral surfaces. The lateral surfaces are in particular of concave design. Battery modules with rounded corners can therewith be accommodated and positively fixed especially well.

It can additionally be provided that at least one first guide structure and/or at least one second guide structure, in particular in the form of a pin, is also provided for positive fixing of a circuit board, wherein a corresponding opening for the respective guide structure or the respective pin is formed in the circuit board. In particular, the circuit board has a plurality of rectangular openings.

In addition to this, the first housing half and/or the second housing half can have additional guide structures for positive fixing of a central control device. A region adjacent to the battery modules can be provided for the central control device, and the guide structures for fixing the control unit can likewise be designed as protruding structures at the respective housing half and be adapted to the geometry of the central control device. Alternatively, or in addition to this, guide structures for fixing at least one cooling body can also be arranged or designed at one of the housing halves.

In a practical embodiment of the housing according to the invention, the first housing half is designed as a plate and the second housing half is likewise designed as a plate. The plates are in particular spaced apart from one another by a front cap and an end cap of the housing. These are arranged in a covering to fix the plates. In particular, the covering is slid over the plates, and the end caps and battery modules arranged between them, after installation of said battery modules. The covering jackets the two housing halves and fixes these. A housing with two housing halves as plates offers the advantage that the plates are simple to manufacture and can be flexibly adapted to changes in the arrangement or shape of the battery modules or additional components, wherein the external shape remains the same due to the covering.

As an alternative to this, the first housing half and the second housing half are a housing shell and a housing cover. The housing shell thereby has a floor surface or top surface and at least one side wall. The housing cover can in particular have only a top surface, and is accordingly designed as a plate. The housing cover can alternatively also have a side wall.

A particularly robust housing which is especially stable relative to acting transverse forces results if the first housing half and the second housing half respectively have a side wall extending orthogonal to the top surface, wherein the side walls overlap at least across a portion of their height.

The respective side walls then rest on one another in the fitting position and prevent a displacement of the housing shell and the housing cover in a direction transverse to the connection direction. In particular, the side walls extend so far that, in the fitting position, they touch the opposing top surface, which as a stop counteracts an action of force in the connection direction. In an overlap region in which the side walls overlap, a seal is in particular provided between the side walls in order to prevent an entrance of moisture and dirt.

In a further practical embodiment, the first housing half and/or the second housing half have guide structures to receive electrical connectors. These guide structures for the connectors enable the contact to the battery modules to be established in optimally any situation. The guide structures serve for the positive fixing of the connectors. Here both connectors to connect the terminals of the battery modules (for power transmission) and connectors for contacting the electronic unit (for transmitting control commands) are referred to as electrical connectors. In particular, the guide structures to accommodate the electrical connectors are designed as pins and protrude relative to the first housing half and/or the second housing half. The electrical connectors have corresponding openings through which the pins can be arranged in a protruding manner. The electrical connectors are in particular connectors for transmitting the electrical power.

The pins in particular have a round outer contour so that the connectors with corresponding opening can be plugged onto the pins in an arbitrary orientation. This enables a flexible wiring of the battery modules. Alternatively, the pins and the connectors can be designed such that they can be plugged onto one another in only one direction and are poka-yoke. Thus such a feature, the pin can, for example, have a projection that interacts with a groove in the connector.

In particular, the pins are additionally arranged and designed such that they additionally protrude between two battery cells of a battery module so that a fixing of the electrical connectors, and a fixed relative arrangement between the connectors and the battery cells assembled into a battery module, are simultaneously enabled.

In particular, the pins have a screw thread in order to enable a particularly secure fixing between the battery modules and the connectors. In particular, the pins have an internal screw thread into which a screw can be screwed that protrudes through the pin and extends through the connector to the battery modules. The electrical contact between battery module and electrical connector can thereby optimally also be ensured even, for example, given warping or twisting of the housing.

As an alternative to the screw connection, a spreading of the pins is also possible so that the adjoining battery models are additionally held in a clamping manner.

If the first guide structures or second guide structures for positive connection of the battery modules, and the guide structures to accommodate electrical connectors, are pins, these in particular extend in the insertion direction. The installation of battery modules and electrical connectors (for signal transmission and/or power transmission) can then take place especially simply in that these are placed or plugged onto the first housing half in a insertion direction.

The guide structures for arrangement of the electrical connectors can also be designed as ribs which laterally adjoin the electrical connectors and laterally guide them. In particular, the electrical connectors can be positively fixed by means of these ribs and first or second guide structures.

In a further practical embodiment of the housing according to the invention, the second guide structures are fashioned in the form of ribs on the second housing half. Oblong structures that protrude relative to the second housing half are referred to as ribs. The ribs are in particular formed on the housing half so that they are respectively arranged projecting in-between battery cells of a battery module and achieve a homogeneous spacing of the battery modules relative to one another.

In particular, the second guide structures have a first group of ribs and a second group of ribs that respectively extend orthogonal to one another. The first group of ribs extend on a top surface with respectively a 90° rotation relative to the second group of ribs. In particular, two adjacent ribs are respectively arranged so that they form a “T”. This “T” formed from two ribs is advantageous in particular for battery modules that have six battery cells with two rows of three battery cells and are wired so that two battery cells in a row are respectively connected and the remaining two battery cells respectively arranged at an end of the two rows. The battery cells are respectively divided up into pairs by the ribs, corresponding to their wiring.

In a practical embodiment of the housing according to the invention, the ribs have at their ends respective insertion slopes in order to be able to be inserted especially well between the individual battery cells of a battery module.

As an alternative or in addition to this, it can be provided that a portion of or all first guide structures and/or second guide structures can be designed as conically tapering pins. That means that the wall surfaces of these pins travel obliquely relative to the extension direction of the pins. The pins increase their outer diameter in the direction of the top surface of the respective housing half. A tolerance compensation can take place via this conicity, and a particularly good positive fit of the battery modules can be achieved.

In a further practical embodiment of the housing according to the invention, this housing is surrounded by an additional outer housing. The outer housing serves for mechanical protection and to protect against environmental influences such as dust and moisture. The outer housing can also be a system housing, for example a tool case. The outer housing can have features with regard to fixing or integration in a warehouse/stacking system.

The housing is especially practical if at least one handle extends between the first housing half and the second housing half. The handle can thereby be designed so that it is fashioned within the outer contour of the first housing half and of the second housing half. The handle does not project laterally relative to the outer contour of the housing halves. In particular, at least one lateral surface of a housing half has a progression curving inward relative to the outer contour, wherein a handle is arranged in the free space between the top surfaces of the housing halves, which handle in particular extends from the first top surface to the second top surface. The handle can be a cylindrical element. The handle element can be ergonomically shaped.

The housing can have, on its outer surface, additional features such as ports for loads and ports for charging the battery cells and display devices. The outer surface can have a device for winding up a cable. In particular, all ports, display devices, or winding devices are arranged within the outer contour of the housing and do not protrude laterally relative to the outer contour. The outer contour is in particular defined by the top surfaces of the two housing halves.

The invention also relates to a battery system with a plurality of battery modules which respectively comprise at least one battery cell and an electronic module, wherein the battery modules are arranged in a housing as described in the preceding. In the housing, the battery modules are positively fixed by the first guide structures of the first housing half and the second guide structures of the second housing half, and are borne securely with respect to shocks and vibrations.

In the housing, the battery modules are arranged in particular in a plurality of rows, and adjacent battery modules arranged in a row are electrically connected with one another. In particular, a central control device is arranged in the housing, and the central control device contacts two battery modules, and the further battery modules are connected between them.

As was already described in the preceding, the first guide structures and/or second guide structures are designed in particular in the form of pins, wherein the pins are respectively arranged at the corners of at least one battery module. The pins can moreover also serve for fixing of a circuit board.

Alternatively, the second guide structures can be designed in the form of ribs and respectively engage between two battery cells of a battery module such that the battery cells are respectively divided into pairs, corresponding to their wiring.

The electrical connection of the battery modules takes place in particular via electrical connectors. The electrical connectors can serve to transmit the power and/or to transmit control commands. The transmission of the power and the transmission of the control commands can be realized via separate connectors or via a common connector. The electrical connection element is in particular a flexible circuit board for transmission of the signal. The circuit board have a meandering design for an additional tolerance compensation. In particular, an electrical connector in the form of a flat metal strip is provided for power transmission.

In a further practical embodiment, guide structures are provided for the arrangement of electrical connectors. In particular, such guide structures are designed as pins, and these pins engage in a corresponding opening of an electrical connector. In particular, these pins also protrude into the battery modules and are respectively arranged between four battery cells adjoining one another.

Alternatively, such guide structures are also designed as ribs which respectively laterally adjoin the electrical connectors.

It is particularly advantageous if the guide structures for guiding or fixing serve a plurality of components. In particular, the first guide structures serve for fixing battery modules and circuit boards, and/or the guide structures for the accommodation of the electrical connectors also serve to guide or fix the battery modules.

In a practical embodiment of the battery system according to the invention, an electrical connecting element has elastic contacts for contacting a battery module or the electronic module.

In particular, the electrical connectors are respectively arranged between the battery modules and a top surface of a housing shell. A particularly simple design and an easy installation thereby result.

The installation is thereby facilitated most of all if the battery modules and the electrical connectors are installed in the housing in a common insertion direction.

The invention should also relate to a method, wherein a first housing half with first guide structures for positive fixing of the battery modules and guide structures for arrangement of electrical connectors is provided, and wherein a plurality of battery modules and electrical connectors are arranged in a common insertion direction on the first housing half. The second housing half is subsequently placed on the first housing half, and the first housing half and second housing half are positively connected.

### BRIEF DESCRIPTION OF THE DRAWINGS

Further practical embodiments and advantages are described in the following in conjunction with Figures. Shown are:

FIG. 1 a battery system according to a first embodiment, in a perspective view angled from above,

FIG. 2 a first housing half of the battery system according to the first embodiment from FIG. 1, in a perspective view angled from above,

FIG. 3 a second housing half of the battery system according to the first embodiment from FIG. 1, in a perspective view angled from above,

FIG. 4 the detail section labeled with IV from FIG. 2, in plan view,

FIG. 5 a battery system according to a second embodiment, in a perspective view angled from the front,

FIG. 6 a battery system according to a third embodiment, in a perspective view angled from above,

FIG. 7 a first housing half of the battery system according to the third embodiment from FIG. 6, in a perspective view angled from above,

FIG. 8 a second housing half of the battery system according to the third embodiment from FIG. 6, in a perspective view angled from above,

FIG. 9 an exploded view of a fourth embodiment of a battery system,

FIG. 10 the battery system from FIG. 9, in a perspective view angled from below,

FIG. 11 a first housing half of the battery system according to the fourth embodiment from FIG. 10, in a perspective view angled from above,

FIG. 12 a second housing half of the battery system according to the fourth embodiment from FIG. 10, in a perspective view angled from above, and

FIG. 13 a battery system according to a fifth embodiment, in a perspective view angled from above.

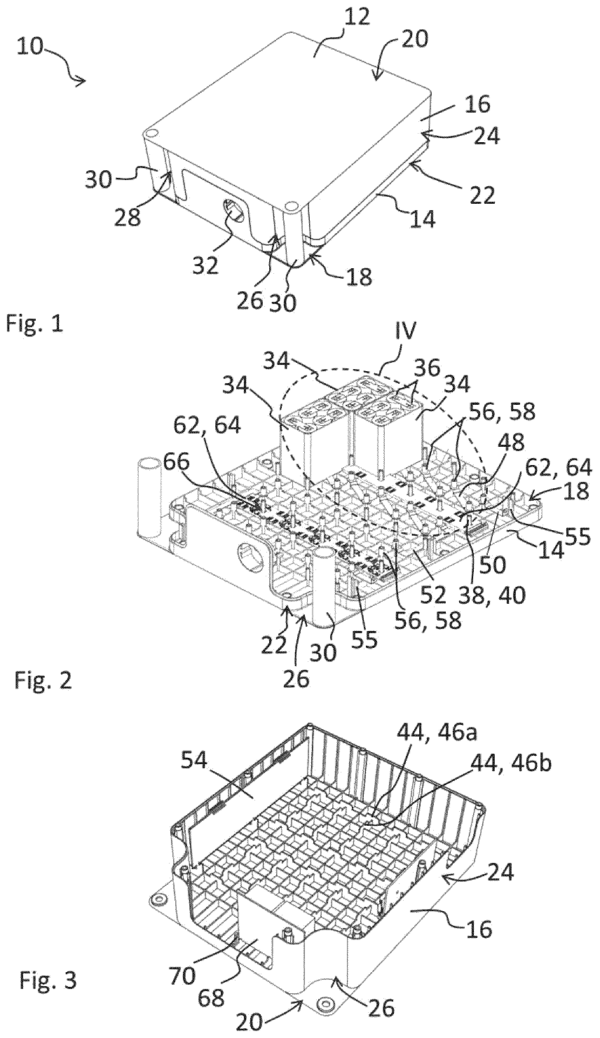

A first embodiment of a battery system 10 is depicted in FIG. 1 through 4.

### DETAILED DESCRIPTION

The battery system 10 comprises a housing 12 whose outside is visible in FIG. 1. Here the housing 12 is formed by a first housing half 14 in the form of a housing cover (cf. FIG. 2) and a second housing half 16 in the form of a housing shell (cf. FIG. 3).

The outer surfaces of the housing 12 form a top surface 18 of the first housing half 14 and a top surface 20 of the second housing half 15, as well as a side wall 22 of the first housing half 14 and a side wall 24 of the second housing half 16. The first housing half 14 and second housing half 16 are connected with one another by means of screws (not shown).

Here the side walls 22, 24 have two inwardly curved regions 26 so that a respective clearance 28 is formed between the two top surfaces 18, 20. A respective cylindrical handle 30 is arranged in this clearance 28, which handle 30 extends from the first top surface 18 to the second top surface 20.

In addition to this, the outside of the housing 12 has at least one port 32 for connecting a load (additional ports and display devices are not shown here).

A plurality of battery modules 34 are arranged within the housing 12. Three battery modules 34 are presently depicted by way of example. The battery modules 34 in turn comprise six battery cells 36 and an electronic module (not visible). The battery modules 34 are arranged in a plurality of rows in the housing. Here, four rows with respectively five battery modules 34 are formed.

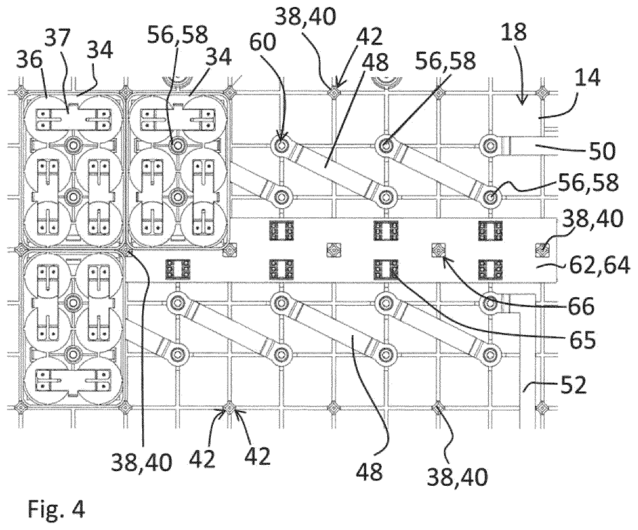

In this first embodiment, the first housing half 14 is designed as a plate and has guide structures 38 in the form of pins 40 (cf. also FIG. 4). Here the pins 40 are respectively arranged at the corners of the regions for the battery modules 34. A plurality of pins 40 are arranged between two or four battery modules 34. The pins 34 are of rectangular design in cross section (or in plan view), wherein the side walls 42 of the pins 40 are curved inward. The pins 40 are therewith adapted to the rounded outer contour of the battery modules 34 (cf. also FIG. 4), and can therewith positively fix the battery modules 34 especially well within the plane of the top surface 18.

The second housing half 16 has additional features for positive fixing of the battery modules 34. The second housing half 16 has second guide structures 44 in the form of ribs 46a, 46b (cf. FIG. 3). There are a first group of ribs 46a and a second group of ribs 46b, wherein the ribs 46a of the first group and the ribs 46b of the second group are aligned orthogonal to one another on the top surface 18. Adjacent ribs 46a, 46b respectively form a “T”. A rib 46a of the first group and a rib 46b of the second group respectively engage in a battery module 34. Here the ribs 46a, 46b engage such that two battery cells 36 that are respectively wired to one another via cell connector 37 are spaced apart from the other battery cells 36 via a rib 46a, 46b.

Electrical connectors 48 are arranged between the top surface 18 of the first housing half 14 and the battery modules 34 for the electrical connection of the battery modules 34 and the transmission of power. Here the electrical connectors 48 for transmission of power are flat metal strips. Additionally, electrical connectors 50, 52 are provided in order to connect the rows of battery modules 34 among one another, or in order to connect the outer rows with a central control unit 54. For fixing and guiding of the electrical connectors 48, 50, 52 for power transmission, the first housing half 14 has guide structures 56 for said electrical connectors. Here these are circular pins 58 that engage in openings 60 of the connectors 48, 50, 52 (cf. FIG. 4). The pins 58 of these guide structures 56 additionally protrude so far that they project between four battery cells 36 of a battery module 34 that respectively adjoin one another, and thus provide for an additional centering. The connectors 48 respectively run diagonally between two rows of guide structures 56, 58.

In this embodiment, the driving of the battery modules 36 takes place via an electrical connector 62 in the form of a circuit board 64 arranged in the first housing half 14. The circuit board 64 has elastic contacts 65 that are connected with corresponding contacts of the battery modules 34 (not visible). The circuit boards 64 are respectively connected at one end with the central control module 54. Rectangular gaps 66 are formed in the circuit board 64, through which the first guide structures 38 protrude and additionally positively fix the circuit board 64.

The battery modules 34 and the electrical connectors for the power 48, 50, 52 and the circuit board 64 are arranged in a common insertion direction S on the first housing half 14.

The positive fixing of the control module 54 takes place via guide structures 55.

The first guide structures 38 and the guide structures 56 for the electrical connectors 48, 50, 52 in the first housing half 14, and the second guide structures 44 of the second housing half 16, are respectively formed integrally with the respective housing half 14, 16.

Furthermore, additional cooling bodies 68 are arranged within the housing 12 and fixed via guide structures 70 that are integrally formed with the respective housing half 14, 16.

In the following, the same reference characters as were used to describe the first embodiment are used for identical or at least functionally identical component parts to describe further embodiments.

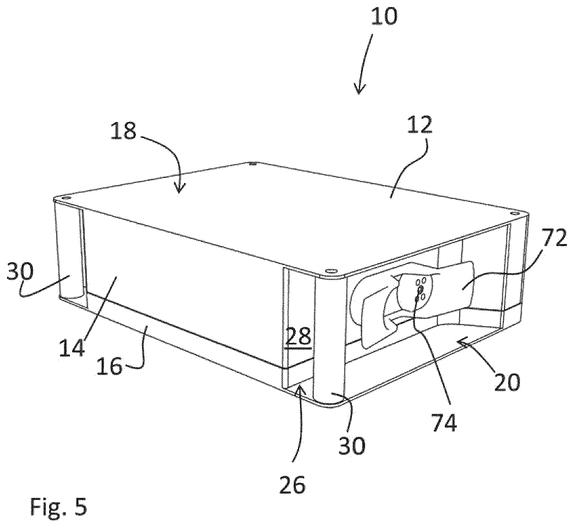

A second embodiment of a battery system 10 is shown in FIG. 5, wherein the housing 12—analogous to the first embodiment—has a first housing half 14 in the form of a cover and a second housing half 16 in the form of a housing shell.

In this second embodiment, the clearance 28 between the first top surface 18 and the second top surface 20 is enlarged relative to the first embodiment. In addition to the two handles 30, a device 72 for winding up a cable is additionally fashioned within the outer contour defined by the top surfaces 18, 20. A port 74 is arranged in the center of the device 72.

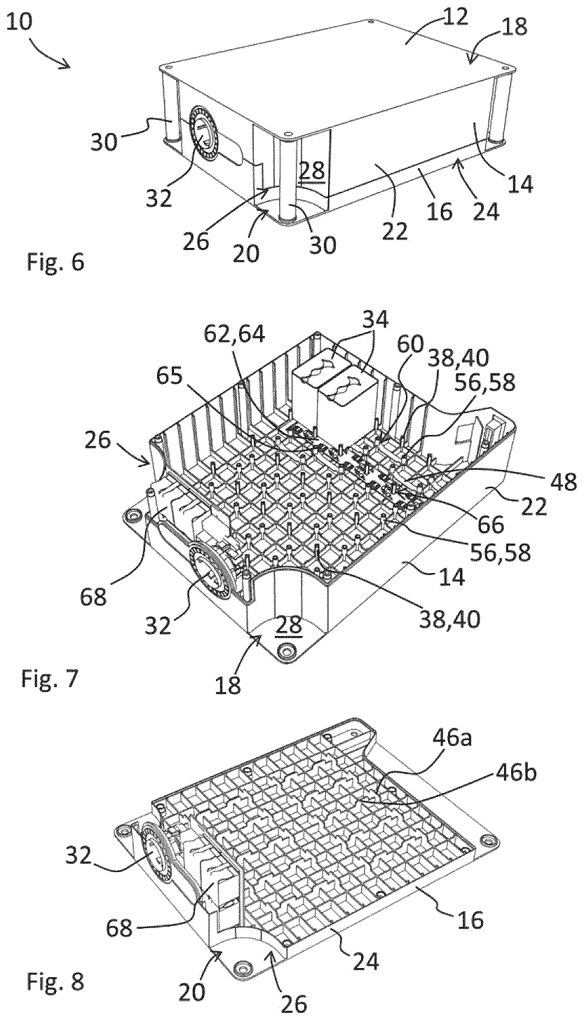

FIG. 6 through 9 show a third embodiment of a battery system. The housing likewise has a first housing half and a second housing half. The difference relative to the first embodiment lies primarily in that here the first housing half 14 is designed as a housing shell with high side walls 22, and the second housing half 16 is designed as a housing cover with low side wall 24. Here the side wall 22 of the first housing half 14 has three clearances 28 for the arrangement of a respective handle 30.

The first guide structures 38 and second guide structures 44, as well as the guide structures 56 for guiding the electrical connectors 48, 50, 52, are identical to the guide structures 38, 44, 56 described in connection with the first embodiment.

The arrangement of the electrical connectors 48 for transmission likewise deviates here; here the connectors 48 run along a row of guide structures 56, 58 (cf. FIG. 5). The connectors 48 are thereby arranged respectively offset in two parallel rows. This illustrates the flexibility of the housing 12, which enables different wiring possibilities in a simple manner.

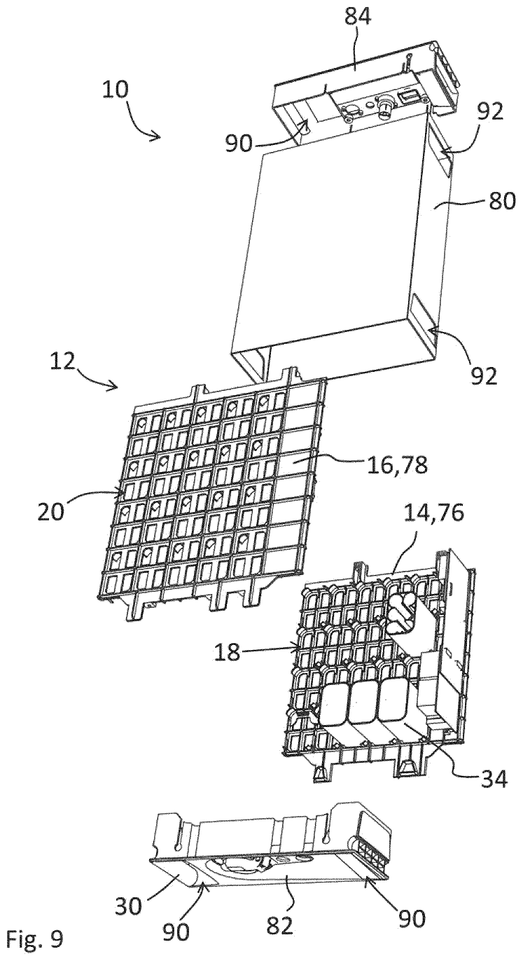

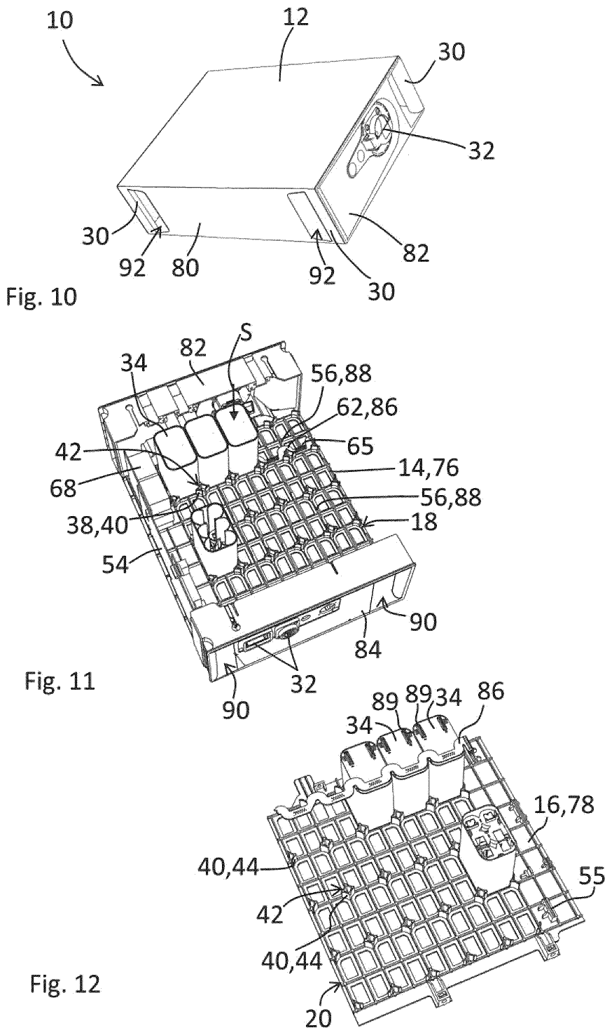

A fourth embodiment of a battery system 10 is depicted in FIG. 9 through 12. This fourth embodiment differs from the previous embodiments in particular due to the design of the housing 10.

Here the housing 12 has a first housing half 14 in the form of a plate 76 and a second housing half 16 in the form of a plate 78. The two plates 76, 78 are arranged in a covering 80, and the face sides are respectively sealed by an end cap 82, 84. The spacing of the plates 76, 78 (or top surfaces 18, 20) takes place via the battery modules 34 arranged between the plates 76, 78 and via the end caps 82, 84. The covering 80 and the end caps 82, 84 positively fix the plates 76, 78.

Here the first housing half 14 also has first guide structures 38 in the form of pins 40. Here the pins 40 have an open geometry, meaning that their outer surface is not closed. The pins 40 can thereby easily deflect and enable a tolerance compensation. As described in connection with FIG. 1 through 4, the side walls 42 of the pins 40 are curved inward in order to positively fix the battery modules 34 with rounded corners. Pins 40 at the end of a row for the battery modules 34 have only two lateral surfaces 42, since they only adjoin two battery modules 34. Pins 40 that adjoin four battery modules 34 have four inwardly curved lateral surfaces 42.

The second housing half 16 has second guide structures 44 which here are likewise designed as pins 40. The pins 40 adjoining four battery modules have a rectangular cross section with inwardly curved lateral surfaces 42. Pins 40 at the end of a row have only two lateral surfaces and are designed in the form of a point.

The first guide structures 38 and second guide structures 44 are integrally designed with the respective housing half 14, 16.

Here the transmission of the control signal respectively takes place via an electrical connector 62 in the form of a flexible, meandering circuit board 86. The circuit board 86 is fixed via guide structures 56 for guiding the electrical connectors, wherein the circuit board 86 rests on the one hand on the first guide structures 38 and on the other hand on ribs 88 formed on the first housing half 14. The ribs 88 and pins 40 are thereby designed such that they form a wandering curve in which the circuit board 86 is laid. Here the circuit board 86 has elastic contacts 65 for easy connection with the battery modules 34. The transmission of power takes place by means of electrical connectors (not shown here) which respectively extend between two terminals 89 of adjacent battery modules 34 (cf. FIG. 12). In particular, ribbon cables are provided as electrical connectors.

Here as well, a central control unit 54 is provided which is borne via suitable guide structures 55 at the first housing half 14 and the second housing half 16.

Still further elements, for example cooling bodies 68 and ports 32, are additionally arranged in the housing 12. Here the ports 32 are arranged in the end caps 82, 84 (not shown in detail).

In the fourth embodiment, the handles 30 are formed in that through-holes 90 are formed at the end caps 82, 84, which through-holes 90 are placed in an opening 92 in the side wall of the covering 80. The end caps 82, 84 at the same time have a cylindrical handle 30.

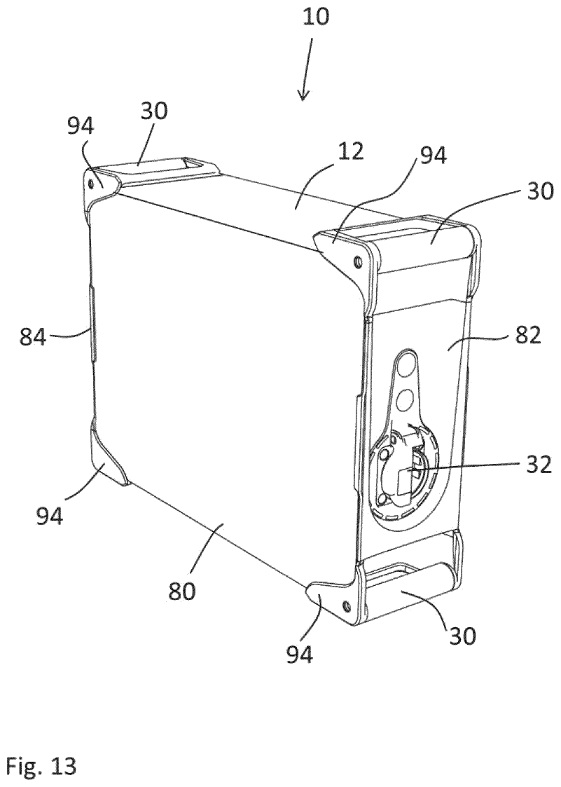

The fifth embodiment in FIG. 13 differs from the fourth embodiment due to the outer design of the housing 12, and in particular of the handle 30. A respective end cap 82, 84 is integrally connected with a handle 30. The handles 30 have support segments 94 with which they externally rest on the covering 80. Two separate handles 30 are also arranged at the covering 80, which separate handles 30 likewise externally rest with a support segment 94 on the covering 80.

### REFERENCE LIST

10 battery system
12 housing
14 first housing half
16 second housing half
18 top surface (first housing half)
20 top surface (second housing half)
22 side wall (first housing half)
24 side wall (second housing half)
26 curved region
28 clearance
30 handle
32 port
34 battery module
36 battery cell
37 cell connector
38 first guide structure
40 pin
42 lateral surface (pin)
44 second guide structure
46a, 46b rib
48 electrical connector (power)
50 electrical connector (power)
52 electrical connector (power)
54 central control device
55 guide structure (for central control device)
56 guide structure (for electrical connector)
58 pin
60 opening
62 electrical connector (signal)
64 circuit board
65 elastic contact
66 gap
68 cooling body
70 guide structure (for cooling body)
72 device for winding up a cable
74 port
76 plate
78 plate
80 covering
82 end cap
84 end cap
86 circuit board
88 rib
89 port
90 through-hole (in the end cap)
92 opening
94 support segment
S insertion direction

1. A housing for a battery system having a plurality of battery modules with respectively at least one battery cell, wherein the housing has a first housing half and a second housing half, wherein the first housing half has first guide structures for positive fixing of the battery modules, and wherein the second housing has second guide structures for positive fixing of the battery modules.

2. The housing according to claim 1,
wherein
the first guide structures, are pins protruding relative to the first housing half, and/or the second guide structures are pins protruding relative to the second housing half.

3. The housing according to claim 2,
wherein
the pins are respectively arranged at a corner of regions provided for battery modules.

4. The housing according to claim 2,
wherein
the pins have at least one inwardly curved lateral surface.

5. The housing according to claim 1,
wherein
the first housing half and/or the second housing half have additional guide structures for positive fixing of a central control device.

6. The housing according to claim 1,
wherein
the first housing half is designed as a plate and the second housing half is likewise designed as a plate, and the plates are arranged in a covering so that the battery modules can be fixed by the covering and the two plates.

7. The housing according to claim 1,
wherein
the first housing half and the second housing half are a housing shell and a housing cover.

8. The housing according to claim 1,
wherein
the first housing half and the second housing half respectively have a side wall, wherein the side walls overlap at least over a portion of their height.

9. The housing according to claim 1,
wherein
the first housing half and/or the second housing half has guide structures to accommodate electrical connectors.

10. The housing according to claim 9,
wherein
the guide structures to accommodate the electrical connectors are designed as pins and project relative to the first housing half and/or the second housing half.

11. The housing according to claim 10,
wherein
the pins have a screw thread for fixing the battery modules.

12. The housing according to claim 9,
wherein
the first guide structures and the guide structures to accommodate electrical connectors extend in an insertion direction.

13. The housing according to claim 1,
wherein
at least a portion of the second guide structures is designed in the form of ribs.

14. The housing according to claim 13,
wherein
the second guide structures have a first group of ribs and a second group of ribs that respectively extend orthogonal to one another.

15. The housing according to claim 1,
wherein
at least a portion of the first guide structures and/or of the second guide structures are designed as conically tapering pins.

16. The housing according to claim 1,
wherein
the housing is surrounded by an additional outer housing.

17. The housing according to claim 1,
wherein
the housing has at least one handle which extends within the outer contour of the housing.

18. A battery system having a plurality of battery modules which respectively comprise at least one battery cell and an electrical module,
wherein
the battery modules are arranged in a housing according to claim 1..

19. The battery system according to the claim 18,
wherein
the first guide structures and/or the second guide structures are designed in the form of pins and are respectively arranged at the corner of at least one battery module.

20. The battery system according to
claim 18,
second guide structures are designed in the form of ribs, wherein the ribs respectively engage between two battery cells of a battery module.

21. The battery system according to claim 18,
guide structures for the arrangement of electrical connectors are designed as pins and engage in a corresponding opening of an electrical connector.

22. The battery system according to claim 18,
guide structures for the arrangement of electrical connectors are designed as ribs, and the ribs laterally adjoin an electrical connector.

23. The battery system according to an claim 18,
wherein
the electrical connectors are respectively arranged between the battery modules and a top surface of a housing half.

24. The battery system according to claim 18,
wherein
the battery modules and the electrical connectors are installed in the housing in a common insertion direction.
